(19) United States
(12) Patent Application Publication
(10) Pub. No.: US 2022/0308268 A1
(43) Pub. Date: Sep. 29, 2022

(54) Barrel Assembly and Head-Mounted Display Device

(71) Applicants: BEIJING BOE OPTOELECTRONICS TECHNOLOGY CO., LTD., Beijing (CN); BOE Technology Group Co., Ltd., Beijing (CN)

(72) Inventors: Haoran JING, Beijing (CN); Zhenxing ZHOU, Beijing (CN); Wenhong TIAN, Beijing (CN)

(21) Appl. No.: 17/424,175

(22) PCT Filed: Jan. 14, 2021
(86) PCT No.: PCT/CN2021/071835

§ 371 Date: Jul. 20, 2021

(30) Foreign Application Priority Data
Mar. 17, 2020 (CN) 202010185473.9

(51) Int. Cl. G02B 3/00; G02B 7/02; H05K 5/00; G02B 3/02; G06F 1/16

(52) U.S. Cl. CPC G02B 3/0062; G02B 7/021; H05K 5/0021; G02B 3/02; G06F 1/163

(57) ABSTRACT

A barrel assembly includes a barrel shell, a display assembly and an imaging assembly. The display assembly is arranged on one end of the barrel shell, the imaging assembly is located inside the barrel shell and close to the other end of the barrel shell, the display assembly includes a fixed plate arranged on the one end of the barrel shell and multiple display modules arranged on the fixed plate, display screens of the multiple display modules are distributed in a matrix, the display screens of the two adjacent display modules are arranged at an included angle, the imaging assembly includes multiple optical lenses that are arranged in a stack, at least one of the optical lenses includes multiple sub-lenses that are spliced together, and the multiple sub-lenses of each optical lens are arranged respectively corresponding to the display screens of the multiple display modules.

### CROSS-REFERENCE TO RELATED APPLICATIONS

The present application is a U.S. National Phase Entry of International Application No. PCT/CN2021/071835 having an international filing date of Jan. 14, 2021, which claims priority to Chinese Patent Application No. 202010185473.9, filed to the CNIPA on Mar. 17, 2020 and entitled “Barrel Assembly and Head-mounted Display Device”. The entire contents of the above-identified applications are hereby incorporated by reference.

### TECHNICAL FIELD

The embodiments of the disclosure relate, but are not limited, to the technical field of virtual reality apparatuses, and in particular to a barrel assembly and a head-mounted display device.

### BACKGROUND

Due to unreasonable structural design, some head-mounted virtual reality devices have small visible ranges, optical lens systems have great object distances, and volumes of products are generally large. In addition, screen door effect is relatively obvious due to screen resolution technical limitation.

### SUMMARY

An overview of a subject elaborated in the disclosure is described below. The overview is not intended to limit the scope of protection of the claims.

The embodiment of the disclosure provides a barrel assembly, including a barrel shell, a display assembly and an imaging assembly. The display assembly is arranged on one end of the barrel shell, the imaging assembly is located inside the barrel shell and close to the other end of the barrel shell, the display assembly includes a fixed plate arranged on the one end of the barrel shell and multiple display modules arranged on the fixed plate, display screens of the multiple display modules are distributed in a matrix, the display screens of two adjacent display modules are arranged at an included angle, the imaging assembly includes multiple optical lenses that are arranged in a stack, at least one of the optical lenses includes multiple sub-lenses that are spliced together, and the multiple sub-lenses of each optical lens are arranged respectively corresponding to the display screens of the multiple display modules.

In an exemplary embodiment, the fixed plate is provided with multiple openings, the display screen of each display module is located in one corresponding opening, and a remaining part of the each display module is clamped on a side of the fixed plate away from the imaging assembly.

In an exemplary embodiment, the display assembly further includes a cover plate, the cover plate covering the side of the fixed plate away from the imaging assembly, and compacting the multiple display modules on the fixed plate.

In an exemplary embodiment, edges of both the cover plate and the fixed plate are fixed on the barrel shell through a fastener.

In an exemplary embodiment, the multiple optical lenses include a first optical lens, a second optical lens, a third optical lens and a fourth optical lens that are arranged sequentially in a stack, the first optical lens is close to the display assembly, the first optical lens includes multiple first aspherical lenses that are spliced together, the second optical lens includes multiple second aspherical lenses that are spliced together, the third optical lens includes multiple planar lenses that are spliced together, and the fourth optical lens is a free-form surface lens.

In an exemplary embodiment, the first optical lens, the second optical lens and the third optical lens are affixed to each other and bonded together as a whole through a binder, an edge of at least one of the first optical lens, the second optical lens and the third optical lens is provided with a first lug, and the first lug is fixed in a first fixation groove arranged on the barrel shell.

In an exemplary embodiment, an edge of the fourth optical lens is provided with a second lug, and the second lug is fixed in a second fixation groove arranged on the barrel shell.

In an exemplary embodiment, the display assembly includes six display modules, and each of the first optical lens, the second optical lens and the third optical lens includes six sub-lenses that are spliced together.

Another embodiment of the disclosure provides a head-mounted display device, including a connecting plate, and a first barrel assembly and a second barrel assembly that are arranged on the connecting plate, both the first barrel assembly and the second barrel assembly are any of the abovementioned barrel assemblies.

In an exemplary embodiment, one end of the first barrel assembly and the second barrel assembly where the display module is located is fixed on the connecting plate, and a shape of a side of the connecting plate facing the first barrel assembly and the second barrel assembly matches a shape of a surface of a corresponding end of the first barrel assembly and the second barrel assembly.

Other aspects may be understood after reading and comprehending the drawings and the detailed description.

### BRIEF DESCRIPTION OF DRAWINGS

The accompanying drawings described herein are used to provide a further understanding of the technical solutions of the disclosure, and constitute a part of the disclosure. Furthermore, the accompanying drawings and the embodiments of the disclosure are used to explain the technical solutions of the disclosure, but do not constitute limitations to the technical solutions of the disclosure.

FIG. 1 is a structure diagram of a barrel assembly according to an embodiment of the disclosure.

FIG. 2 is an exploded view of a barrel assembly in FIG. 1.

FIG. 3 is a structure diagram of two barrel assemblies of a head-mounted display device according to an embodiment of the disclosure.

FIG. 4 is an exploded view of a head-mounted display device in FIG. 3.

### DETAILED DESCRIPTION

The technical solutions of the disclosure will be further described below in combination with the drawings through specific embodiments. It is to be understood that specific embodiments described here are used to explain the disclosure only, rather than intended to limit the disclosure. It is to be noted that the embodiments in the disclosure and features in the embodiments may be combined with each other without conflict.

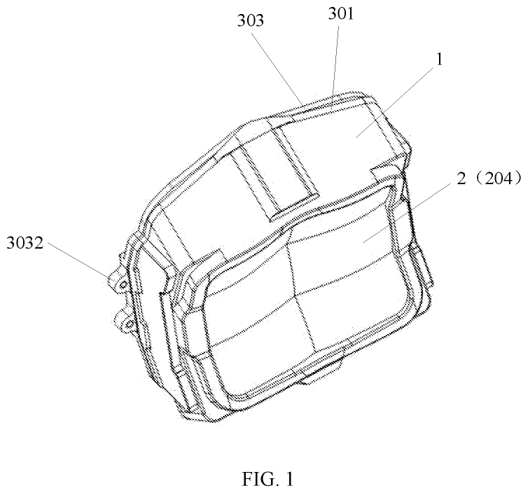

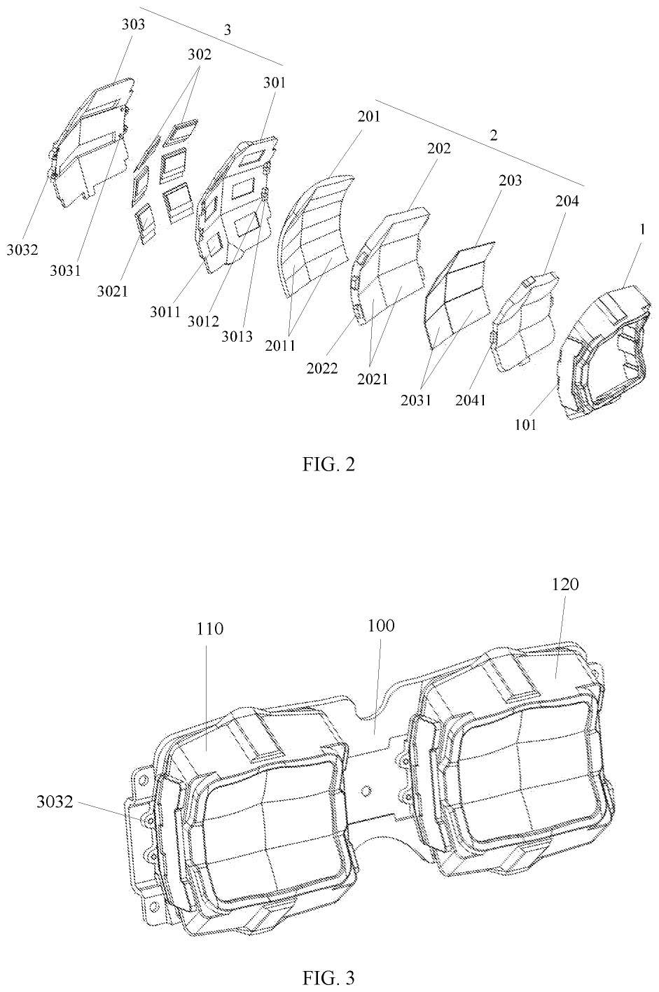

As shown in FIG. 1 and FIG. 2, the embodiment provides a barrel assembly, including a barrel shell 1, a display assembly 3 and an imaging assembly 2. The display assembly 3 is arranged on one end of the barrel shell 1, the imaging assembly 2 is located inside the barrel shell 1 and close to the other end of the barrel shell 1, the display assembly 3 includes a fixed plate 301 arranged on the one end of the barrel shell 1 and multiple display modules 302 arranged on the fixed plate 301, display screens 3021 of the multiple display modules 301 are distributed in a matrix, the display screens 3021 of two adjacent display modules 302 are arranged at an included angle, the imaging assembly 2 includes multiple optical lenses (in some embodiments, a first optical lens 201, a second optical lens 202, a third optical lens 203 and a fourth optical lens 204 are included) that are arranged in a stack, at least one of the optical lenses includes multiple sub-lenses that are spliced together, and the multiple sub-lenses of each optical lens are arranged respectively corresponding to the display screens 3021 of the multiple display modules 302.

With the adoption of the barrel assembly of the embodiment of the disclosure, the multiple display screens 3021 are distributed in a matrix, two adjacent display screens 3021 are arranged at an included angle, and multiple optical lenses are correspondingly arranged in a stack. Compared with a solution in which one display screen is arranged in the related art, resolution expansion of the barrel assembly may be realized, screen door effect is reduced, and a visible range is enlarged. Meanwhile, a distance between the display screen 3021 of the display module 302 and the optical lens may be designed to be small, in this way an object distance of the imaging assembly 2 is reduced, refraction and reflection of lights may be implemented between the multiple optical lenses for many times, a light path may be shortened, and accordingly a volume of the barrel assembly may be effectively reduced.

As shown in FIG. 2, in some exemplary embodiments, the fixed plate 301 is provided with multiple openings 3011, the display screen 3021 of each display module 302 is located in one corresponding opening 3011, and a remaining part of the each display module 302 is clamped on a side of the fixed plate 301 away from the imaging assembly 2. Herein, the fixed plate 301 plays a role of bearing the multiple display modules 302, and a shape of the fixed plate 301 may be designed according to a distribution mode of the multiple display modules 302. Display sides of the display screens 3021 of the multiple display modules 302 face the imaging assembly 2, and images displayed by the multiple display screens 3021 are presented as images suitable for human eyes after being subjected to refraction and reflection by the multiple optical lenses of the imaging assembly 2.

As shown in FIG. 1 and FIG. 2, in some exemplary embodiments, the display assembly 3 further includes a cover plate 303. The cover plate 303 covers the side of the fixed plate 2 away from the imaging assembly 2, and compacts the multiple display modules 302 on the fixed plate 301. Herein, both the cover plate 303 and the fixed plate 301 may be fixed on the barrel shell 1. In the embodiment, the cover plate 303, the multiple display modules 302 and the fixed plate 301 of the display assembly 3 are arranged in a stack, the whole display assembly 3 is arranged on the end of the barrel shell 1, and the multiple optical lenses of the imaging assembly 2 are arranged inside the barrel shell 1 in a stack. The whole barrel assembly is compact in structure, and accordingly the volume of the whole barrel assembly may be effectively reduced.

As shown in FIG. 1 and FIG. 2, in some exemplary embodiments, edges of both the cover plate 303 and the fixed plate 301 are fixed on the barrel shell 1 through a fastener. In an example of the embodiment, the barrel shell 1 may be a cylindrical structure with openings on two ends. The edge of the fixed plate 301 is provided with multiple first fixation holes 3012, a position on the edge of the cover plate 303 corresponding to the multiple first fixation holes 3012 is provided with multiple second fixation holes 3031, and the fastener (such as a screw) is fixed on the barrel shell 1 after passing through the second fixation hole 3031 and the first fixation hole 3012. A border position of the fixed plate 301 facing the side of the barrel shell 1 may be provided with multiple bumps 3013 (FIG. 2 shows four bumps 3013, and both sides of the fixed plate 301 are provided with two bumps 3013), and each bump 3013 is provided with one first fixation hole 3012. Correspondingly, the barrel shell 1 is provided with multiple clamping grooves 101 that are in clamped connection with the multiple bumps 3013 respectively. Through clamped fitting of the bumps 3013 and the clamping grooves 101, fixation reliability of the display assembly 3 and the barrel shell 1 may be further improved.

As shown in FIG. 2, in some exemplary embodiments, the multiple optical lenses include a first optical lens 201, a second optical lens 202, a third optical lens 203 and a fourth optical lens 204 that are arranged sequentially in a stack. The first optical lens 201 is close to the display assembly 3, the first optical lens 201 includes multiple first aspherical lenses 2011 that are spliced together, the second optical lens 202 includes multiple second aspherical lenses 2021 that are spliced together, the third optical lens 203 includes multiple planar lenses 2031 that are spliced together, and the fourth optical lens 204 is a free-form surface lens. Herein, images displayed by the multiple display screens 3021 may be presented as images suitable for human eyes after being subjected to refraction and reflection for many times by the four optical lenses that are arranged in a stack.

As shown in FIG. 2, in some exemplary embodiments, the first optical lens 201, the second optical lens 202 and the third optical lens 203 are affixed to each other and bonded together as a whole through a binder, an edge of at least one of the first optical lens 201, the second optical lens 202 and the third optical lens 203 is provided with a first lug 2022, and the first lug 2022 is fixed in a first fixation groove arranged on the barrel shell 1. In an example of the embodiment, affixed surfaces of the first optical lens 201 and the second optical lens 202 are compatible with each other, and affixed surfaces of the second optical lens 202 and the third optical lens 203 are compatible with each other. Thus, the first optical lens 201, the second optical lens 202 and the third optical lens 203 are bonded together as a whole, and no gap is generated between the three. Multiple first lugs 2022 may be arranged, for example, the edge of the second optical lens 202 is provided with six first lugs 2022, the multiple first lugs 2022 are in one-to-one conjunction with multiple first fixation grooves that are correspondingly arranged on an inner side of the barrel shell 1, and the first lugs 2022 and the first fixation grooves may be bonded and fixed with the binder. In the embodiment, Ultraviolet curing adhesive (UV adhesive) may be used as the binder arranged to bond the optical lenses.

As shown in FIG. 2, in some exemplary embodiments, an edge of the fourth optical lens 204 is provided with a second lugs 2041, the second lugs 2041 is fixed in a second fixation groove arranged on the barrel shell 1. In an example of the embodiment, multiple second lugs 2041 (FIG. 2 shows four second lugs 2041) may be arranged, the multiple second lugs 2041 are in one-to-one conjunction with multiple second fixation grooves that are correspondingly arranged on the inner side of the barrel shell 1, and the second lugs 2041 and the second fixation grooves may be bonded and fixed with the binder.

As shown in FIG. 2, in some exemplary embodiments, the display assembly 3 includes six display modules 302, and each of the first optical lens 201, the second optical lens 202 and the third optical lens 203 includes six sub-lenses that are spliced together. In an example of the embodiment, the display screens 3021 of the six display modules 302 are distributed in three rows and two lines. Each display screen 3021 may be planar, an included angle is formed between two adjacent display screens 3021, and the included angle is an obtuse angle. Optical axes of the six aspherical lenses of each of the first optical lens 201 and the second optical lens 202 are arranged perpendicular to the six display screens 3021 respectively, and six planar lenses 2031 of the third optical lens 203 are arranged in parallel with the six display screens 3021 respectively. The six display modules 302 may be Organic Light Emitting Diode (OLED) display modules 302 (which may be 0.39-inch screen).

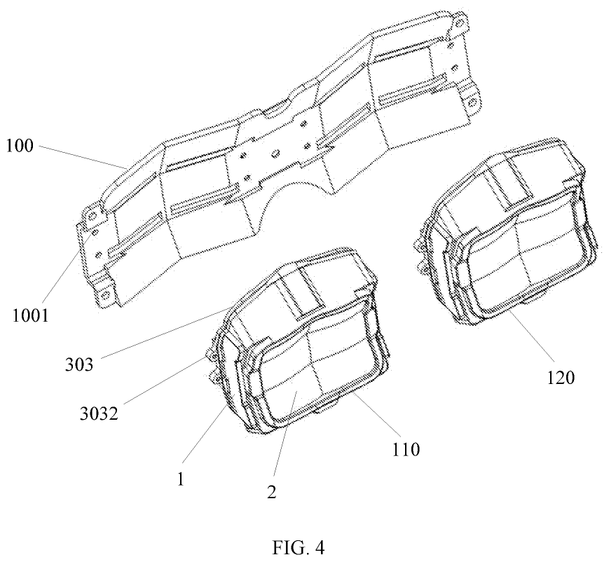

As shown in FIG. 3 and FIG. 4, the embodiment of the disclosure further provides a head-mounted display device, including a connecting plate 100, and a first barrel assembly 110 and a second barrel assembly 120 that are arranged on the connecting plate 100, both the first barrel assembly 110 and the second barrel assembly 120 are a barrel assembly as described above.

The head-mounted display device of the embodiment of the disclosure has a monocular resolution up to 3840×3240, in this way screen door effect is reduced, a visible range of a product is enlarged, an object distance is small, and a volume of the product may be effectively reduced.

As shown in FIG. 1-FIG. 4, in some exemplary embodiments, one end of the first barrel assembly 110 and the second barrel assembly 120 where the display assembly 3 is located is fixed on the connecting plate 100, and a shape of a side of the connecting plate 100 facing the first barrel assembly 110 and the second barrel assembly 120 matches a shape of a surface of a corresponding end of the first barrel assembly 110 and the second barrel assembly 120. In an example of the embodiment, sides of cover plates 303 of display assemblies 3 of the first barrel assembly 110 and the second barrel assembly 120 away from a fixed plate 301 are fixed on the connecting plate 100. A shape of the connecting plate 100 facing a side of the cover plate 303 is consistent with a shape of the cover plate 303 away from a side of the fixed plate 301, in this way the cover plate 303 may be affixed with the connecting plate 100. An edge of the cover plate 303 may be provided with multiple bulges 3032 (the drawing shows four bulges 3032), and each bulge 3032 is in connection with a third fixation hole 1001 that are arranged on the connecting plate 100 through a screw and other fasteners. The head-mounted display device may further include a shell, and the connecting plate 100 may be fixed on the shell.

In some exemplary embodiments, the cover plate 303, multiple display modules 302 and the fixed plate 301 of the display assembly 3 are arranged in a stack and in contact with each other, and the cover plate is in contact with the connecting plate 100 in an affixed manner. Such a cascading contact structure may effectively distribute heat generated by the multiple display modules 302 evenly on a contacted structure part, in this way effective heat dissipation effect may be achieved. In the head-mounted display device of the embodiment, except a necessary part (such as an optical lens) made from a nonmetallic material, the connecting plate 100, the cover plate 303, the fixed plate 301, the barrel shell 1 and other parts may be made from metallic materials, in this way the heat dissipation effect is further improved.

To sum up, with the adoption of the barrel assembly of the embodiments of the disclosure, the multiple display screens are distributed in a matrix, the two adjacent display screens are arranged at an included angle, and the multiple optical lenses are correspondingly arranged in a stack. Compared with the solution in which one display screen is arranged in the related art, the resolution expansion of the barrel assembly may be realized, the screen door effect is reduced, and the visible range is enlarged. Meanwhile, the distance between the display screen of the display module and the optical lens may be designed to be small, in this way the object distance of the imaging assembly is reduced, refraction and reflection of the lights may be implemented between the multiple optical lenses for many times, the light path may be shortened, and accordingly the volume of the barrel assembly may be effectively reduced.

In the description of the embodiments of the disclosure, unless otherwise definitely specified and limited, terms “connect”, “fixedly connected”, “mount” and “assemble” should be broadly understood. For example, the terms may refer to fixed connection and may also refer to detachable connection or integral connection. The terms “mount”, “connect” and “fixedly connected” may refer to direct connection and may refer to indirect connection through a medium as well, or communication in two components. For those of ordinary skill in the art, specific meanings of the abovementioned terms in the embodiments of the disclosure can be understood according to a specific condition.

What is claimed is:

1. A barrel assembly, comprising: a barrel shell, a display assembly and an imaging assembly;
wherein, the display assembly is arranged on one end of the barrel shell, and the imaging assembly is located inside the barrel shell and close to the other end of the barrel shell;
the display assembly comprises a fixed plate arranged on the one end of the barrel shell and multiple display modules arranged on the fixed plate, display screens of the multiple display modules are distributed in a matrix, and the display screens of two adjacent display modules are arranged at an included angle; and
the imaging assembly comprises multiple optical lenses that are arranged in a stack, at least one of the optical lenses comprises multiple sub-lenses that are spliced together, and the multiple sub-lenses of each optical lens are arranged respectively corresponding to the display screens of the multiple display modules.

2. The barrel assembly according to claim 1, wherein, the fixed plate is provided with multiple openings, the display screen of each display module is located in one corresponding opening, and a remaining part of the each display module is clamped on a side of the fixed plate away from the imaging assembly.

3. The barrel assembly according to claim 2, wherein, the display assembly further comprises a cover plate; the cover plate covers the side of the fixed plate away from the imaging assembly, and compacts the multiple display modules on the fixed plate.

4. The barrel assembly according to claim 3, wherein, edges of the cover plate and the fixed plate are fixed on the barrel shell through a fastener.

5. The barrel assembly according to claim 1, wherein, the multiple optical lenses comprise a first optical lens, a second optical lens, a third optical lens and a fourth optical lens that are arranged sequentially in a stack, and the first optical lens is close to the display assembly; and
the first optical lens comprises multiple first aspherical lenses that are spliced together, the second optical lens comprises multiple second aspherical lenses that are spliced together, the third optical lens comprises multiple planar lenses that are spliced together, and the fourth optical lens is a free-form surface lens.

6. The barrel assembly according to claim 5, wherein, the first optical lens, the second optical lens and the third optical lens are affixed to each other and bonded together as a whole through a binder; and
an edge of at least one of the first optical lens, the second optical lens and the third optical lens is provided with a first lug, and the first lug is fixed in a first fixation groove arranged on the barrel shell.

7. The barrel assembly according to claim 5, wherein, an edge of the fourth optical lens is provided with a second lug, and the second lug is fixed in a second fixation groove arranged on the barrel shell.

8. The barrel assembly according to claim 5, wherein, the display assembly comprises six display modules, and each of the first optical lens, the second optical lens and the third optical lens comprises six sub-lenses that are spliced together.

9. A head-mounted display device, comprising a connecting plate, and a first barrel assembly and a second barrel assembly that are arranged on the connecting plate, wherein both the first barrel assembly and the second barrel assembly are the barrel assembly according to claim 1.

10. The head-mounted display device according to claim 9, wherein, one end of the first barrel assembly and the second barrel assembly where the display module is located is fixed on the connecting plate, and a shape of a side of the connecting plate facing the first barrel assembly and the second barrel assembly matches a shape of a surface of a corresponding end of the first barrel assembly and the second barrel assembly.
